(19) United States
(12) Patent Application Publication
(10) Pub. No.: US 2015/0332364 A1
(43) Pub. Date: Nov. 19, 2015

(54) Service Definition Monitor

(71) Applicant: MOOSE LOOP HOLDINGS, LLC, Salt Lake City, UT (US)

(72) Inventors: Ken R. Davis, Salt Lake City, UT (US); Fraser M. Smith, Salt Lake City, UT (US)

(73) Assignee: MOOSE LOOP HOLDINGS, LLC, Salt Lake City, UT (US)

(21) Appl. No.: 14/276,941

(22) Filed: May 13, 2014

(51) Int. Cl. G06Q 30/06

(52) U.S. Cl. CPC G06Q 30/0613; G06Q 30/0641

(57) ABSTRACT

A technology is described for monitoring a task definition. The technology may include receiving a task definition from a customer that includes task details for a task to be performed for the customer. The task definition may then be compared to a predetermined criterion where the criterion indicates that the customer may be entering the task definition incorrectly. A task definition that meets the predetermined criterion can be identified and the task definition may be provided to a customer service representative for review.

### BACKGROUND

Many goods may be purchased in a commoditized way. A consumer can have certain criteria when deciding to purchase goods, and if the goods meet the desired criteria, then the consumer generally does not care who provides the goods.

Services have traditionally been less commoditized. Rather, services are typically purchased after comparing service providers to one another. For example, service providers may be compared through a bidding process, interviews, and/or online user feedback ratings. Such service provider comparisons may be challenging for a consumer to interpret due the non-uniformity in services supplied by various service providers. This has resulted in uncertainty to the consumer as to the comparative cost of services, reliability of services, and the quality of services provided by service providers.

### BRIEF DESCRIPTION OF THE DRAWINGS

FIG. 1 is a block diagram illustrating an example system for monitoring a task definition provided by a customer.

FIG. 2 is a flow diagram illustrating an example method for monitoring customer tracing input.

FIG. 3 is a diagram that illustrates an example graphical user interface used to create a task definition.

FIG. 4 is a diagram illustrating an example image of a property that includes a plurality of task definitions.

FIG. 5 is a flow diagram illustrating an example method for monitoring a task definition.

FIG. 6 is block diagram illustrating an example of a computing device that may be used for monitoring a task definition and assisting a customer with tracing input.

### DETAILED DESCRIPTION

A technology is described for monitoring a task definition input by a customer who may be purchasing a service. The task definition input may be compared to criteria that indicate that a customer may be confused or may be entering task definition input incorrectly. If the task definition input matches certain criteria, then a customer service representative may be notified and the customer may be assisted by the customer service representative. A task definition may be a set of instructions that a customer provides to a service provider or task broker. The instructions may describe the type of task to be performed and may include task details, such as a task location, a specific area of a property or building where the task is to be performed, a specific item that is to be serviced, as well as other types of task details depending upon the task. Further, task details may include geometric definitions. For example, the size of a lawn to be mowed or the size of a driveway to be shoveled may be included in the task details.

Customers that purchase a service via a task broker may do so without much deference as to who performs the service. Rather, a customer's concern may be that the service is performed by a service provider according to certain criteria. For example, a customer may purchase a lawn mowing task via a task broker. The customer may not care who actually performs the lawn mowing service, as long as the service is performed according to the criteria that the customer requested. Meeting the customer's criteria may be considered providing a quality service. In a commoditized services market, customers may have difficulty using an electronic interface to accurately define a service that may be performed by a service provider.

More accurate and efficient access to services may be used to commoditize services not traditionally commoditized in the past by allowing the services to be priced and delivered in a more uniform fashion. Such access to services can be provided by operations implemented using networking and computing hardware. For example, a market may be provided where customers may purchase services or tasks via an electronic source, such as a service provider or service broker that operates an electronic task exchange accessible to customers via a computer network (e.g., the Internet). In addition to using an electronic task exchange to purchase a service, customers may use the graphical user interface of the electronic task exchange to provide instructions that define the service.

Customers can define a service by providing instructions that outline the service to be performed. For example, a customer may specify a location and an area within a location where a service provider is to perform a service. As a specific example, a customer purchasing snow removal from an electronic task exchange may provide an address for a property where the snow removal service is to be performed and may also provide instructions detailing the areas of the property where snow is to be removed. In one example, an electronic image of the property may be provided to a customer that shows characteristics of the property, such as structures, parking lots, driveways, walkways, etc. The electronic image may be a satellite image, a map image or a schematic image of a property. A customer may be provided with the electronic image as a representation of the actual property and may use an electronic tracing tool to mark or outline the areas of the property where a service may be performed. For instance, a customer purchasing snow removal service may trace a parking lot and walkways on an electronic image representing the property. A cost of a task may be based on a calculation using the areas traced by a customer. In other words, the cost of a task may be based on the task definition. For example, a cost of a task may be based upon a total number of square feet upon which a task is desired to be performed, as represented by the areas traced by a customer.

In some cases, customers may not be familiar with the tools provided with a graphical user interface and may not understand how to use a tool to define a service. For example, a customer may be unfamiliar with graphical tracing tools and how to use the tool to trace an area of an image to indicate an area where a task may be performed. In other cases, customers may not understand that a task definition may be used to calculate a price for the service. As an example, a customer using a graphical tracing tool may define an area that may be smaller or larger than the actual area that the customer intends to be serviced, resulting in an incorrect cost estimate for the performance of the task. In the case where a customer may be confused or may enter an incorrect task definition, the present technology may monitor the actions of the customer while the customer is providing input and can alert a customer service representative to assist the customer.

In one example configuration, tracing input may be received from a customer to define an area of a physical location where the customer would like a task to be performed. The tracing input may be entered by the customer using a graphical input tracing tool. An example of a graphical input tracing tool is line tool or a geometric shape, such as rectangle or oval, that may be used for tracing or surrounding an area graphically. The tracing input may be compared with a set of predetermined criteria, where a criterion indicates that the customer may be experiencing difficulty entering the tracing input. In a case where the tracing input meets any of the predetermined criteria, the tracing input may be flagged. The flagged tracing input may then be provided to a customer service representative via a customer service client device along with a notification that the tracing input meets at least one of the predetermined criteria.

In another example configuration, tracing input entered by a customer may be monitored as the customer enters the tracing input. As the customer enters the tracing input, the tracing input can be compared to a set of predetermined criteria. In a case where the tracing input meets any of the predetermined criteria, a notification may be sent to a customer service representative using a customer service client device. The notification may trigger a communication between the customer service client device and a client device used by the customer. The customer service representative may then assist the customer with entering the tracing input. In one example, the tracing input may be displayed on the customer service client device as the customer enters the tracing input, thus allowing the customer service representative to see what the customer is doing and assist the customer. In another example, a customer service representative may enter the tracing input using the customer service client device and a customer may view on the customer's client device the tracing input as the tracing input is being entered by the customer service representative.

In yet another example configuration, a customer may enter tracing input that meets a predetermined criterion and may be provided with machine generated feedback advising the customer that the tracing input has met the predetermined criterion. In one example, a customer may be provided with a notification explaining the predetermined criterion that the tracing input has met, and a suggestion on how to enter the tracing input correctly may be provided. In a case where the customer may need further assistance in entering the tracing input, the customer may be connected with a customer service representative. In one example, a customer may connect with a customer service representative via a graphical user interface control, such as “contact customer representative” button. Alternatively, a customer service representative may be notified that a customer may need assistance after a predetermined time period has passed since the machine generated feedback was provided.

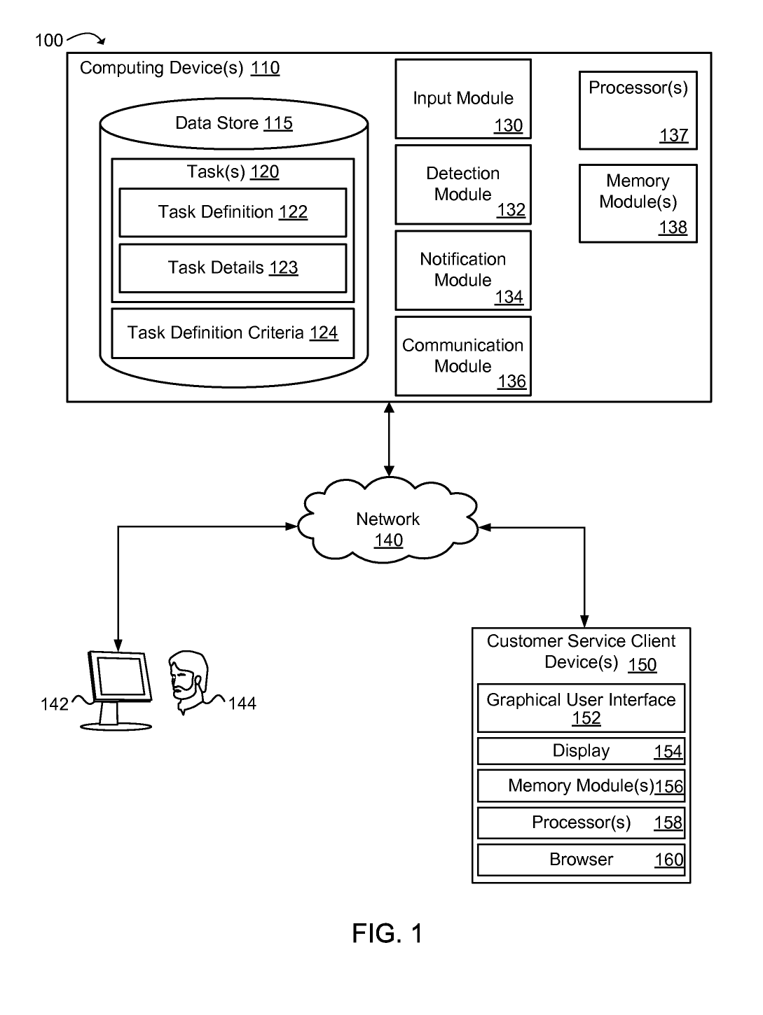

FIG. 1 illustrates a system 100 that may be used to monitor a customer's actions as the customer enters a task definition. The system 100 may include one or more computing devices 110 that monitor task definitions received from a customer 144 via a customer client device 142. A computing device 110 may also be in communication with a number of customer service client devices 150 over a communications network 140. The communications network 140 may be a local area network (LAN), wide area network (WAN), or the Internet. A graphical user interface may be provided to a customer 144 using a customer client device 142 that enables the customer 144 to enter a task definition. For example, a web application executed within a browser on the customer client device 142 may provide the customer 144 with a graphical user interface.

The computing device 110 may include a data store 115. Data in the data store 115 may include, for example, tasks 120 with an associated task definition 122 and task details 123. A task definition 122 may be, in one example, tracing input provided by a customer that defines a physical area where a task may be performed. In one example, task details 122 may include: the task type, location, scheduled start time, estimated task time, customer instructions and any other detail that may be related to a task. For instance, using a customer client device 142, a customer 144 may enter a task definition 122 and the task definition 122 would then be sent to the computing device 110 and stored in the data store 115.

The data store 115 may also include task definition criteria 124. The task definition criteria 124 may be a set of predefined criteria that may be used by the system 100 to determine whether a customer 144 may be entering the task definition 122 correctly. Also, the task definition criteria 124 may be used to detect whether a customer 144 may be confused, at which point electronic feedback (e.g., a text message or graphical notification) may be provided or a customer service representative may be notified so that the customer service representative may assist the customer 144.

The computing device 110 may contain various modules that may be executed on the computing device 110. Among the modules that may be executed on the computing device 110 may be an input module 130, detection module 132, notification module 134 and communication module 136. The input module 130 may be configured to provide a customer with a graphical user interface (GUI) depicting a graphical representation of a physical location that enables the customer 144 to provide a task definition 122 by, for example, tracing an area on the graphical representation of the physical location. For example, a customer 144 using a customer client device 142 may use a graphical tracing tool provided by the GUI to outline a task area. In another example, a customer 144 may provide a task definition 122 by entering a numerical value, such as a measurement or a percentage to define a task area or by entering text instructions.

The detection module 132 may be configured to compare a task definition 122 received from a customer 144 with the task definition criteria 124. The task definition criteria may be used to identify a customer 144 who may be entering a task definition 122 incorrectly or to identify a customer that may not understand how to enter a task definition 122. In one example configuration, the computing device 110 may receive a task definition as a customer 144 using a customer client device 142 enters the task definition. As the computing device 110 receives the task definition, the detection module 132 may compare the task definition with the task definition criteria 124. The task definition criteria 124 may be a set of conditions that when met or violated indicate that the task definition is incorrect or that a customer 144 may be experiencing difficulty in entering the task definition 122.

An example criterion of the task definition criteria 124 may be an amount of time that has elapsed from the time the customer 144 began entering a task definition 122 to a present time. For example, when a customer begins to enter a task definition 122, the detection module 132 may record the time when input was first received. The detection module 132 may then compare the amount of time that may have passed since the first input was received. If the amount of time that has passed exceeds an amount of time specified by the task definition criterion 124 and the last input (e.g., completing the tracing) has not been received, then the detection module 132 may flag the task definition 122 as violating the time specified by the task definition criterion 124. As a specific example, a customer may begin to trace an area on an electronic image depicting where a service is to be performed. The customer may become confused while tracing the area and may not complete the tracing. After a predetermined amount of time has elapsed, a customer service representative may be notified who then may assist the customer 144. Alternatively, a message may be displayed on the customer client device 142 asking the customer 144 if the customer 144 would like assistance.

In another example of a task definition criterion 124, a narrowness of a polygon drawn by a customer 144 in relation to an area detected in an electronic image of a physical location where the task is to be performed may be used to identify a customer that may not understand how to properly size the polygon. For instance, a customer 144 using a customer client device 142 may be provided with a graphical user interface that includes electronic tools for drawing a number of polygons over an area on an electronic image representing a physical location. The polygons may define an area where a task may be performed and may provide an area from which a cost calculation for the task may be determined. In a case where a customer 144 may draw a polygon on top of a graphical image representing a location where a service is to be performed, and the polygon may be narrower than the area where the task is to be performed, the detection module 132 may compare the polygon drawn by the customer 144 with machine detected area boundaries or expected area boundaries (e.g., parking lot, yard, room, etc.) of the electronic image. The machine detection can detect edge boundaries in the image using existing computer graphics edge detection techniques. Where the polygon may be narrower than the area boundaries of the electronic image, the detection module 132 can identify the customer 144 and a customer service representative may be notified who can then assist the customer 144.

Another example of a task definition criterion 124 may be a total number of polygons created and placed by a customer 144 on an area boundary of an electronic image representing a physical location in order to define a task area. In a case where a customer 144 creates multiple polygons and places the polygons in an area boundary of an electronic image where fewer polygons are expected to be used to define the task area, the over use of polygons may indicate that the customer 144 does not understand how to use a polygon to define a task area. The detection module 132 may compare the number of polygons placed in an area boundary by a customer 144 with the total area of the area boundary. Using the total area of the area boundary, the detection module 132 may determine the least number of polygons that may be placed within the area boundary. If the number of polygons exceeds the least number of polygons determined by the detection module 132, the detection module may then identify the customer 144 and a customer service representative can then assist the customer 144.

Another task definition criterion 124 can be an overlapping of the task definition 122 onto an adjoining physical location depicted on an electronic image of a physical location. For example, a customer 144 may trace an area of an electronic image where a task may be performed, but may trace beyond the task area boundaries onto an adjacent physical location depicted in the electronic image. The detection module 132 may compare the task definition 122 provided by a customer 144 with the task area boundaries of the electronic image to determine whether the task definition 122 overlaps any of the task area boundaries. If the task definition 122 does overlap any of the task area boundaries, then the detection module 132 may then identify the customer 144 and a customer service representative can assist the customer 144. For example, if a customer traces an area that overlaps into a neighbor's yard for lawn mowing, then this tracing may be flagged for review by a customer service representative.

A further example of a task definition criterion 124 may be a task definition 122 that may be noncontiguous. For example, a customer 144 may use a tracing tool to draw multiple polygons on top of an electronic image. The polygons may be placed in a task area of the electronic image where a contiguous polygon may be placed rather than multiple polygons. The detection module 132 may analyze the boundaries of the task area and may determine based upon the boundaries being contiguous that a single contiguous task definition 122 may be placed in the task area. In a case where the detection module 132 determines that a task definition 122 may be unexpectedly noncontiguous, the detection module 132 can identify the customer 144 and the customer 144 can receive assistance.

In one example configuration, customers who may have had difficulty with entering task definitions in the past can be identified when the customer accesses the system 100 to enter a new task definition. The customer then can receive assistance as the customer enters a task definition, or, as another example, the task definition entered by the customer can be reviewed.

In another example configuration of the technology, historical data can be used to detect a discrepancy in a task definition. For example, historical data can be stored for a task definition associated with a particular customer and property. The historical data can be retrieved and compared to a task definition for the same property when the customer enters a new task definition. When a comparison reveals a discrepancy between the historical data and a new task definition, the new task definition can be analyzed by a customer service representative to determine whether an error was made by the customer when entering the new task definition.

Also, using historical data, a probability can be calculated that predicts that a task definition will be entered incorrectly. The historical data used can be for a customer, a particular task, and/or the location of a particular task. For example, if a customer is prone to entering incorrect task definitions, then based on historical data, the probability that the customer will enter an incorrect task definition may be high. In a case where a particular task may have a high occurrence of task definition errors, historical data can be used to identify that the particular task has a high occurrence of task definition errors and steps can be taken to mitigate task definition errors, or the particular task can be flagged for review. Certain task locations may also be prone to task definition errors. Historical data can identify these task locations so that when a task definition is received for the task location, the task definition can be marked for review to determine whether an error was made when entering the task definition.

In another example configuration, comparisons of task definitions to predetermined criteria can be collected and stored. Comparison data collected can be analyzed to determine a likelihood that a customer will make an error when entering a task definition. Thus, when a customer enters a task definition under similar circumstances, the task definition can be, for example, flagged for review because the likelihood that the task definition contains an error may be higher compared to other task definitions. In addition, data collected of the comparisons can be used to develop new criteria that can be used to detect task definition errors.

After identifying a customer 144 that may be entering an incorrect task definition 122 or identifying a customer who may be experiencing problems entering a task definition 122, the detection module 132 may provide the identity of the customer 144 to the notification module 134. The notification module 134 may be configured to notify a customer service representative using a customer service client device 150 when a task definition 122 matches at least one of the task definition criteria 124. In one example configuration, the notification module 134 may be provided with a customer ID and a description of the task definition criterion 124 that was met. The notification module 134 may then send a notification containing the customer ID and description of the task definition criterion 124 to one of a number of customer service client devices 150. A customer service client device 150 may be operated by a customer service representative who may assist a customer 144 by communicating with the customer 144 over a network 140, such as the Internet. The notification module 134 may manage notifications by assigning a notification to a particular customer service representative or the notification may be placed in a queue and assigned to the next available customer service representative. Upon receiving a notification, a customer service client device 150 may display an alert notifying an associated customer service representative that a customer may need assistance.

A communication module 136 may be configured to provide communication between a customer 144 and a customer service representative by, in one example, allowing the customer service representative to use a customer service client device 150 to view and manipulate objects on a customer's client device screen. A customer service representative may assist a customer 144 by, for example, correcting a task definition, tracing a task area, suggesting task areas to define, answering customer 144 questions, as well as any other type of assistance that the customer service representative may provide. In one example, upon receiving a notification, a customer service representative may request access to a customer's client device 142 by asking a customer 144 for permission. After obtaining access to the customer's client device 142, the customer service representative may then collaboratively assist the customer 144 in entering the task definition 122. In another example, upon receiving a notification, a customer service representative may communicate with a customer 144 via voice over a network. The customer service representative may assist the customer 144 by talking with the customer and if needed may be granted access to the customer's client device 142. Alternatively, using a customer service client device 150, a customer service representative may enter a suggested task definition 122 for a customer 144 and then send the suggested task definition 122 to the customer for approval. As can be appreciated, there may be multiple methods in which a customer service representative may assist a customer 144 via a network 140 and any of these methods are within the scope of this disclosure.

The computing device 110 of FIG. 1 may be a single server, a distributed server environment, a server farm, or any computing device or group of computing devices that may service requests from other computing devices or programs. In addition, the computing device 110 may include one or more processors 137 and memory modules 138. Various processes and/or other functionality may be executed in the system 100 according to various embodiments. Also, various data may be stored in a data store 115 that may be accessible to the computing device 110. The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store 115 may include storage systems such as a SAN (Storage Area Network), cloud storage network, volatile or non-volatile RAM, optical media, or hard-drive type media. The data store 115 may be representative of a plurality of data stores 115.

The customer service client device 150 may include a processor 158 and a memory module 156. The customer service client device 150 may be a device such as, for example, a desktop computer, a laptop, a tablet, a mobile device, a smart phone or any device with like capability. Additionally, the customer service client device 150 may contain a graphical user interface (GUI) 152 that may enable a customer service representative to view a customer client device's screen and manipulate objects displayed on the customer client device's screen. A browser 160 may be included on the customer service client device 150 in which a customer service web application may be executed. The customer service client device 150 may include a display 154, such as a liquid crystal display (LCD) screen, gas plasma-based flat panel display, LCD projector, cathode ray tube (CRT), or other types of display devices, etc. The customer service client device 150 may include hardware that may enable the customer service client device 150 to connect to a network 140.

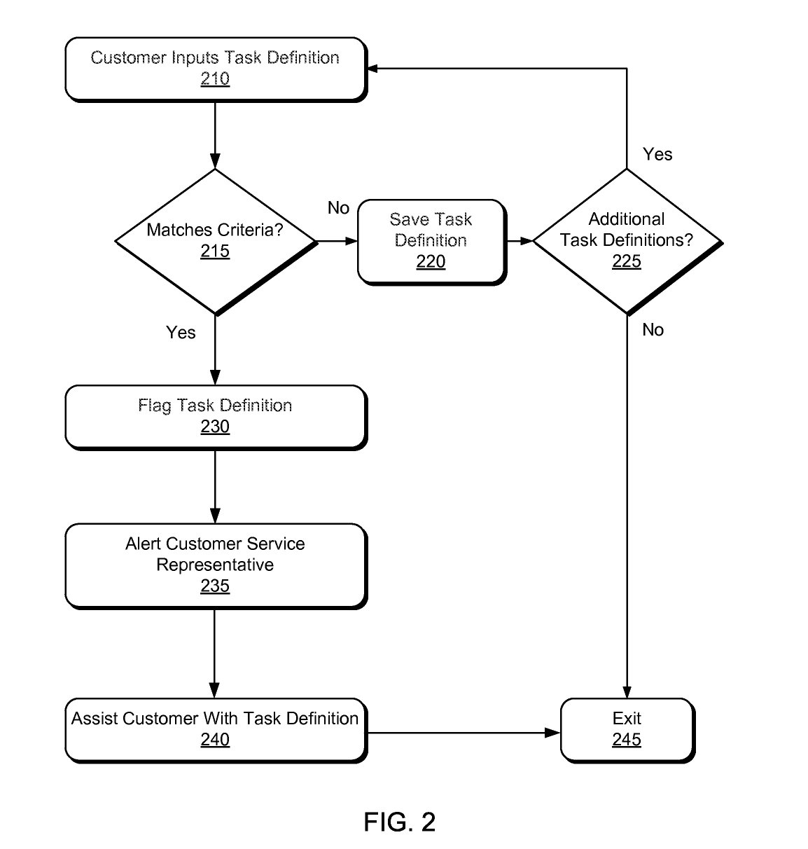

Moving now to FIG. 2, a flow diagram illustrates an example method for monitoring customer tracing input. Beginning with block 210, a customer may input a task definition for a task that a customer may want performed. The task definition may define an area of a physical location where the task may be performed. For example, using a computer and an electronic tracing tool, a customer may trace an area within an electronic image that may depict a real property. The customer may use the tracing tool to trace a polygon on the electronic image where the space within the polygon represents an area of the real property where a task may be performed.

In one example, as a customer traces a task definition using a client device, the task definition may be provided to a server where the task definition may be compared to a set of predetermined criteria to determine whether the task definition meets any of the predetermined criteria. A task definition that meets one or more of the predetermined criteria may be an indication that a customer may be experiencing difficulty in entering a task definition. In another example, when a customer completes a task definition (e.g., traces a complete polygon) the task definition may be sent to a server where the server will then compare the task definition to a set of predetermined criteria. In yet another example, a client device used by a customer may compare a task definition with a set of criteria that may be located in the memory of the client device.

As in block 215, a task definition may be compared with a set of predetermined criteria to determine whether the task definition meets any of the conditions of the predetermined criteria. In a case where a task definition does not meet any of the conditions of the predetermined criteria, as in block 220, the task definition may be saved so that a service provider may use the task definition as a reference when the service provider performs the task. As in block 225, if a customer wishes to provide additional task definitions for a task, the customer may enter another task definition and process may continue as described above, otherwise, as in block 245, the process will exit.

In a case where a task definition may meet a condition of any of the predetermined criteria, the task definition may be identified and, as in block 230, the task definition may be flagged so that the task definition may be reviewed by a customer service representative. In block 235, a customer service representative may be alerted by providing the task definition to a customer service client device along with a notification that may provide the customer service representative an explanation why the task definition has been flagged. Upon receiving the notification and the task definition, as in block 240, the customer service representative may assist the customer with the task definition. In one example configuration, the notification sent to a customer service client device may trigger a communication between the customer service client device and a customer's client device. For example, a communication may be a message that may be displayed on the customer's client device asking if the customer would like assistance.

Assistance may be provided to a customer by a customer service representative using one or more various methods. For example, a customer service representative may use an application that enables the customer service representative to view a live image of the customer's computer screen using the customer service representative's computer. Thus, the customer service representative may instruct the customer as the customer traces a task definition. As another example, a customer service representative may provide assistance by creating a task definition for the customer based on the customer's instructions. For instance, the customer service representative may use a remote application that allows the customer service representative to control the customer's computer and trace the task definition for the customer. Also, the customer service representative may create the task definition using a customer service computer and provide the customer with an electronic image of the task definition via email, instant messaging, or a similar communication channel so the customer can approve the task definition. Communication between a customer service representative and a customer may be accomplished over a telephone line or by way of instant messaging, email, text, as well as other communication methods that enable a customer service representative to communicate with a customer.

Alternatively, in a case where a task definition may meet a condition of the predetermined criteria, a customer may be provided with an option to correct the task definition. In one example, a customer may be presented with an option that when selected programmatically corrects errors included in a task definition, such as an auto-correction function. As an illustration, where a customer may have selected a roof of a dwelling for a lawn mowing task definition, an auto-correction feature may be used to programmatically adjust the task definition to exclude the roof. In another example, a customer may be provided with a recommendation that can be used to correct a task definition. For example, based on the illustration above, a customer may be prompted with a recommendation to remove the roof area of a dwelling from a task definition. In another example, where a customer may have entered a task definition for a task that already has a task definition (i.e., a duplicate task definition), an auto-correction feature may programmatically remove the duplicate task definition entry, or a recommendation may be presented to the customer advising that the duplicate task definition be deleted.

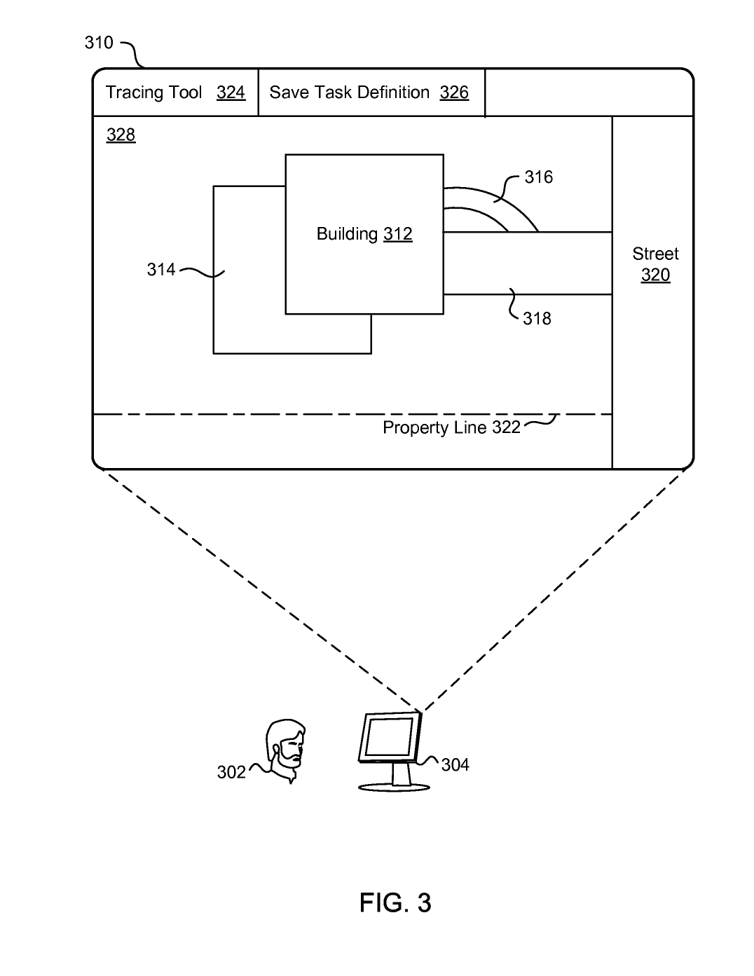

FIG. 3 illustrates an example graphical user interface 310 that may be used to trace an area where a customer may wish a task to be performed. A customer 302 using a client device 304 may view an electronic image 328 of a real property displayed within the graphical user interface 310. In one example, the electronic image 328 of the real property may be a drawing depicting a real property. In another example, the electronic image 328 of the real property may be a photograph, such as a satellite image, aerial photograph, street side photograph, or other photograph depicting all or a portion of a real property. The electronic image 328 may depict certain features of a real property. For instance, the electronic image 328 may show a building 312, a patio 314, a walkway 316, a driveway 318 as well as a street 320 that runs along the front of the real property and a property line 322 that divides one real property from another real property. As can be appreciated, an electronic image 328 of a real property may depict many other features not listed above. The features shown in the electronic image 328 are merely illustrative and are not meant to limit the scope of what can be shown in an electronic image of a real property.

The graphical user interface 310 may provide a customer 302 with functionality that enables the customer 302 to trace an area of the electronic image 328 representing an area where the customer 302 would like a task to be performed. Tracing tools 324 may be made available via the graphical user interface 310. In one example, the tracing tools 324 may provide a customer 302 with a tool that can be used to draw a polygon on the electronic image 328 using a pointing device such as a computer mouse. In another example, a customer 302 using a touch screen device may be used to trace a polygon using a touch screen stylus or the customer's finger. In a further example, the tracing tools 324 may provide various graphical shapes (e.g., circle, triangle, square, rectangle, etc.) to a customer 302 that may be overlaid onto an electronic image 328 and may be scaled, rotated or manipulated so that the shape creates an outline of an area where the customer 302 would like a task performed. As will be appreciated, any method that enables a customer to mark an electronic image 328 falls within the scope of the present technology. After a customer 302 has traced an area on the electronic image 328, the customer 302, in one example, may save the electronic image 328 with the tracing as a task definition by selecting a save control 326 displayed in the graphical user interface 310.

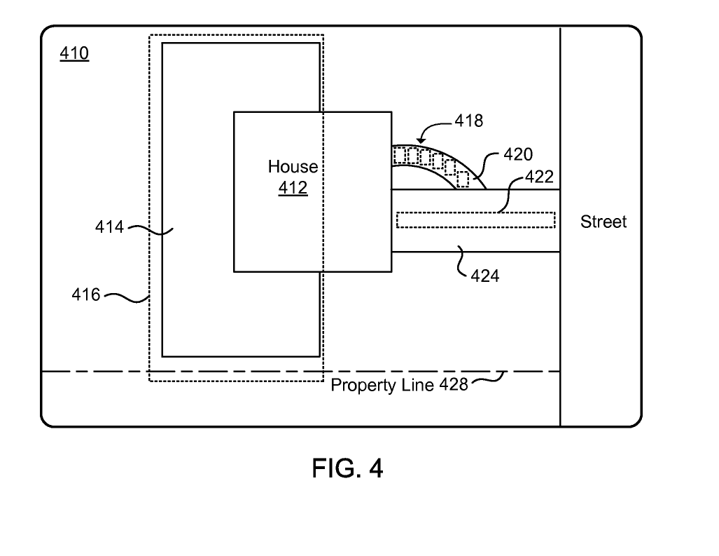

FIG. 4 illustrates an example electronic image 410 of a real property showing a number of task definitions that may be traced onto the electronic image 410. The electronic image 410 further depicts features of the real property that may be identified and used to determine whether a task definition meets a condition of a predetermined criterion. A task definition that meets a condition of a predetermined criterion may indicate that a problem exists with the task definition. Because a price to perform a task by a service provider may be based on a task definition that a customer defines, a task definition that does not accurately describe the area where the task is to be performed may affect the price calculated for the task. Therefore, comparing a task definition with predetermined criteria may prevent a customer from entering an inaccurate task definition.

One example of a predetermined criterion may be a narrowness of a polygon in relation to an area depicted in an electronic image 410 of a physical location. Edge detection and/or area detection technologies may be used to determine an area depicted in the electronic image 410. For example, a mathematical computing process may be used to identify points in the electronic image 410 where image brightness changes dramatically or has discontinuities. The points may be a boundary within which edges of a polygon may be placed. As an illustration, an electronic image 410 may depict a customer's driveway 424 from which the customer would like to have snow removed. The customer may trace a polygon 422 on an area of the electronic image 410 representing the driveway where the area represents the location where the customer would like snow removed. The polygon 422 traced by the customer may be compared to the area representing the driveway 424 to determine whether the polygon 422 may be too narrow in relation to the area representing the driveway 424.

Another example of a predetermined criterion may be a number of polygons created and placed in an area of the electronic image 410 in relation to a bounded area that the polygons may be placed. For example, a walkway 420 may be identified in the electronic image 410 and a customer may trace multiple polygons 418 within the bounded area of the walkway 420 where the customer would like a task performed. Because the bounded area of the walkway 420 contains multiple polygons 418 or multiple polygons representing a small physical area, then the condition of the predetermined criterion may be met and a customer service representative may be notified that the task definition may need to be reviewed.

Similar to the predetermined criterion example above, a predetermined criterion may be a polygon that may be noncontiguous to another polygon within a bounded area on the electronic image 410. Based on the example above, the walkway 420 may be considered a bounded area that contains a number of noncontiguous polygons 418. Because some of the polygons 418 may be close in proximity (e.g., butt up against one another) and could be joined to form a single contiguous polygon, the task definition for the walkway 420 may be defined better with the help of a customer service representative.

Another predetermined criterion example may be an overlapping of a polygon onto an adjoining location depicted on the electronic image 410. For example, the electronic image 410 may show a property line 428 that divides one real property from another real property. A customer may trace a polygon 416 on the electronic image 410 for an area 414 that the customer would like lawn care to be performed. When the customer traced the polygon 416, the customer may have extended the polygon 416 past the property line 428. Because the polygon 416 crosses the property line 428, the condition of the predetermined criterion may have been met.

An additional predetermined criterion example may be an overlapping of a polygon onto an area depicted in the electronic image 410 that may be inconsistent to the task that a customer wishes to be performed. As an example, a customer may want an area 414 of lawn to be mowed. The customer may trace a polygon 416 on the electronic image 410 that outlines the area 414, but the polygon 416 may also extend onto the customer's house 412. Because a task of mowing a lawn is inconsistent with the area of the house that the polygon 416 extends to, a condition of the predetermined criterion may be met.

Yet another example of a predetermined criterion may be overlapping of a polygon 416 outside of a bounded area 414 (e.g., fenced area) depicted on the electronic image 410. For example, the bounded area 414 may be a lawn that a customer may want a service provider to maintain. When the customer traced the bounded area 414, the customer may have traced the polygon 416 so that the polygon 416 overlaps or significantly extends outside the bounded area 414, thus meeting a condition of the predetermined criterion.

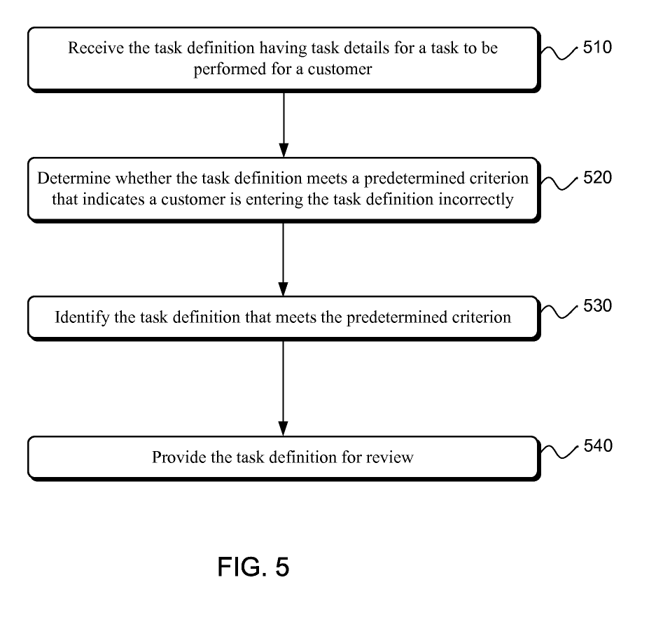

FIG. 5 is a flowchart illustrating an example method for monitoring a task definition. As in block 510, a task definition having task details for a task to be performed for a customer may be received. A task definition may be input provided by a customer via a client computing device that defines an area depicted on an electronic image representing a real property where the customer would like a task to be performed. In one example, a graphics editor can be used to provide the input that defines a task definition. For example, using a graphics editor, a customer can draw a polygon on top of an image of a property where the customer wishes a task to be performed. The resulting image can then be analyzed to determine the area of the task definition in relation to the image of the property.

As in block 520, a determination may be made whether the task definition meets a predetermined criterion that indicates a customer may be entering the task definition incorrectly. In addition to the predetermined criterion examples described in FIG. 4, an example of a predetermined criterion may be an amount of time that may have elapsed from the time a customer began entering a task definition to the present time. For example, a customer may begin to trace a polygon onto an electronic image but may not know how to complete the polygon. Thus, the customer may spend a greater amount of time than would normally be expected for a customer to finish tracing the polygon. When an amount of time elapses from a time when the customer begins tracing a polygon to a present time that exceeds an accepted amount of time to complete a polygon, the condition of the predetermined criterion may be met.

Another example of a predetermined criterion may be a criterion that a task definition does not exceed a calculated estimate of a task definition parameter by a predetermined margin. In other words, a task definition entered by a customer should not exceed that of an area that has been estimated for the task definition. The estimation can be calculated using a computing module that, for example, can analyze an image of a property and identify locations where a task may be performed. For example, locations within the image where lawn care may be performed can be identified. Using the computing module, a mathematical area of the location can be estimated and the task definition can be compared to the mathematical area. The absolute value of a difference between the estimate and the task definition can then be compared to a predetermined margin. If the difference exceeds the predetermined margin, then the condition of the predetermined criterion may be met.

The predetermined criteria discussed herein can be associated with a specific task. Because the locations of a property vary from one task to another, a predetermined criterion may be associated with a specific task and attributes of the predetermined criterion can be defined to match the task. As an illustration, a lawn care task involves areas of a property where grass can be grown, whereas a snow removal task involves areas of a property where snow is removed. Therefore, a predetermined criterion that identifies specific areas of a property (e.g., cement or asphalt) where snow removal may take place can be associated with a snow removal task. Likewise, where a predetermined criterion identifies locations of a property where lawn care may be performed, the predetermined criterion can be associated with a lawn care task.

As in block 530, a task definition that meets a predetermined criterion may be identified so that, as in block 540, the task definition may be provided for review. In one example, task definitions that have been identified and/or marked for review may be placed in a queue that can be assigned to a customer service representative. Further, those task definitions placed in the queue can be ranked so that the customer service representative may handle a task definition based upon the rank assigned to the task definition.

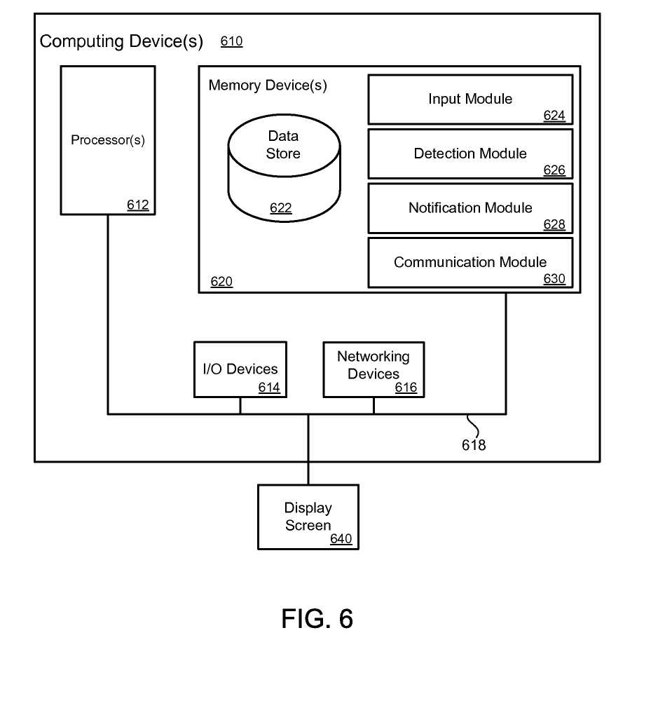

FIG. 6 illustrates a computing device 610 on which modules of this technology may execute. A computing device 610 is illustrated on which a high level example of the technology may be executed. The computing device 610 may include one or more processors 612 that are in communication with memory devices 620. The computing device 610 may include a local communication interface 618 for the components in the computing device. For example, the local communication interface may be a local data bus and/or any related address or control busses as may be desired.

The memory device 620 may contain modules that are executable by the processor(s) 612 and data for the modules. Located in the memory device 620 are modules executable by the processor(s) 612. For example, an input module 624, a detection module 626, a notification module 628, a communication module 630, and other modules may be located in the memory device 620. The modules may execute the functions described earlier. A data store 622 may also be located in the memory device 620 for storing data related to the modules and other applications along with an operating system that may be executable by the processor(s) 612.

Other applications may also be stored in the memory device 620 and may be executable by the processor(s) 612. Components or modules discussed in this description that may be implemented in the form of software using high programming level languages that are compiled, interpreted or executed using a hybrid of the methods.

The computing device may also have access to I/O (input/output) devices 614 that are usable by the computing devices. An example of an I/O device may be a display screen 640 that may be available to display output from the computing devices. Other known I/O device may be used with the computing device as desired. Networking devices 616 and similar communication devices may be included in the computing device. The networking devices 616 may be wired or wireless networking devices that connect to the internet, a LAN, WAN, or other computing network.

The components or modules that are shown as being stored in the memory device 620 may be executed by the processor(s) 612. The term “executable” may mean a program file that may be in a form that may be executed by a processor 612. For example, a program in a higher level language may be compiled into machine code in a format that may be loaded into a random access portion of the memory device 620 and executed by the processor 612, or source code may be loaded by another executable program and interpreted to generate instructions in a random access portion of the memory to be executed by a processor. The executable program may be stored in any portion or component of the memory device 620. For example, the memory device 620 may be random access memory (RAM), read only memory (ROM), flash memory, a solid state drive, memory card, a hard drive, optical disk, floppy disk, magnetic tape, or any other memory components.

The processor 612 may represent multiple processors and the memory 620 may represent multiple memory units that operate in parallel to the processing circuits. This may provide parallel processing channels for the processes and data in the system. The local interface 618 may be used as a network to facilitate communication between any of the multiple processors and multiple memories. The local interface 618 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for monitoring customer tracing input, comprising:
under control of a processor and memory configured with executable instructions,
receiving tracing input from a customer defining an area of a physical location where a task is to be performed;
examining the tracing input to determine whether the tracing input meets a predetermined criterion that indicates that a customer is experiencing difficulty entering the tracing input;
flagging the tracing input that meets the predetermined criterion for review; and
providing the tracing input and a notification to a customer service client that the tracing input meets the predetermined criterion.

2. A method as in claim 1, further comprising triggering a communication with a customer service representative's client device.

3. A method as in claim 1, wherein a traced area of an electronic image depicts an area of a real property where the task is being requested.

4. A method as in claim 1, further comprising displaying the tracing input on a customer service representative's client device as the customer provides the tracing input.

5. A method for monitoring a task definition, comprising:
under control of a processor and memory configured with executable instructions,
receiving the task definition having task details for a task to be performed for a customer;
determining whether the task definition meets a predetermined criterion that indicates that a customer is entering the task definition incorrectly;
identifying the task definition that meets the predetermined criterion; and
providing the task definition for review.

6. A method as in claim 5, wherein determining whether the task definition meets the predetermined criterion further comprises monitoring the task definition as the task definition is being entered by a customer.

7. A method as in claim 6, wherein a notification is provided to a customer service client device triggering a communication between the customer service client device and a customer's client device enabling a customer service representative to assist the customer with the task definition.

8. A method as in claim 6, further comprising providing the customer with an option selected from at least one of: programmatically correcting the task definition or recommending a change to the task definition that corrects the task definition, when the task definition meets the predetermined criterion.

9. A method as in claim 5, wherein the predetermined criterion is an amount of time that has elapsed from a time the customer began entering the task definition to a present time.

10. A method as in claim 5, wherein the predetermined criterion is a number of polygons created and placed in an available area of an electronic image of a physical location in relation to the available area of the electronic image of the physical location.

11. A method as in claim 5, wherein the predetermined criterion is an overlapping of a polygon onto an adjoining physical location depicted on an electronic image of a physical location.

12. A method as in claim 5, wherein the predetermined criterion is an overlapping of a polygon onto an area of a physical location that is inconsistent to the task that is to be performed.

13. A method as in claim 5, wherein the predetermined criterion is a task definition that exceeds a computer calculated estimate of a task definition parameter by a predetermined margin.

14. A method as in claim 5, wherein the predetermined criterion is a polygon on an electronic image of a physical location that is noncontiguous to another polygon on the electronic image.

15. A method as in claim 5, wherein the predetermined criterion is a narrowness of a polygon traced onto an electronic image of a physical location in relation to an area depicted in an electronic image of a physical location where the polygon is being created.

16. A method as in claim 5, wherein the predetermined criterion is overlapping of a polygon traced onto an electronic image outside of a bounded area depicted on the electronic image of a physical location.

17. A method as in claim 5, further comprising associating a predetermined criterion with a specific task.

18. A method as in claim 5, further comprising determining a price to perform a task based upon the task definition provided by the customer.

19. A method as in claim 5, further comprising identifying a historical task definition associated with the customer and a property, wherein the property associated with the historical task definition is the property associated with the task definition; and
comparing the historical task definition with the task definition to determine whether a discrepancy exists between the historical task definition and the task definition.

20. A method as in claim 5, further comprising identifying a customer who has previously had difficulty in defining a task.

21. A method as in claim 5, further comprising collecting data of comparisons of the predetermined criterion with the task definition, wherein the data is used to determine a likelihood that the customer will make an error when entering the task definition and to identify new criteria used to indicate that a customer is entering a task definition incorrectly.

22. A method as in claim 5, further comprising calculating a probability that a task definition will be entered incorrectly using historical data for the customer, the task or a location for the task definition.

23. A method as in claim 5, wherein the task definition is provided to a customer service representative for review.

24. A method as in claim 23, further comprising ranking a plurality of task definitions that have been marked for review and placing the plurality of task definitions in a queue assigned to the customer service representative according to the rankings.

25. A non-transitory machine readable storage medium, including program co when executed to cause a machine to perforin the method of claim 5.

26. A system for monitoring a task definition provided by a customer, comprising:
a processor;
a criteria data store containing task definition criteria;
a memory device including instructions, that when executed by the processor, cause the processor to execute:
a detection module configured to compare the task definition from the customer with the task definition criteria to identify a customer that is entering the task definition incorrectly; and
a review module configured to notify a customer service representative and provide the task definition for review when the task definition matches at least one of the task definition criteria.

27. A system as in claim 26, further comprising an input module configured to provide to the customer a graphical user interface depicting a graphical representation of a physical location and to enable the customer to provide a task definition by tracing an area of the graphical representation of the physical location.

28. A system as in claim 26, further comprising of a communication module configured to provide communication between a customer and a customer service representative by allowing the customer service representative to use a customer service representative's client device to view and manipulate graphical objects on a customer's client device screen.
